(19) United States
(12) Patent Application Publication
(10) Pub. No.: US 2015/0377755 A1
(43) Pub. Date: Dec. 31, 2015

(54) APPARATUS FOR TENSILE TEST BY COMPRESSION

(71) Applicant: BERDAN ARGE BILISIM YAZILIM DNS. MÜH. BAGL. ELEMAN. ÜRETIM VE LAB. HIZ. SAN.TIC. A.S., Yenisehir (TR)

(72) Inventor: Hasan SEMSI, Tarsus (TR)

(21) Appl. No.: 14/737,664

(22) Filed: Jun. 12, 2015

(30) Foreign Application Priority Data
Jun. 27, 2014 (TR) 2014/07579

(51) Int. Cl. G01N 3/08

(52) U.S. Cl. CPC G01N 3/08

(57) ABSTRACT

A tensile test apparatus that enables tensile tests on test specimens such as metallic pieces shaped into stud/bolt by means of a compression method, wherein the apparatus includes a centering sleeve that enables centering of the tensile test apparatus to fit on the tray of the hydraulic press, a lower grip part that enables gripping of the stud/bolt (test specimen) movably positioned in the center sleeve from one end, and containing the bearing area of the pressure appliers on which the pressure applier applies pressure, an upper grip part that enables gripping of the stud/bolt (test specimen) immovably positioned in the center sleeve from the other end, and containing pressure applier holes within which the pressure applier passes through, and a press ram that transfers the compressive force to the lower grip part via the pressure appliers.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to apparatus for tensile test by compression propounded for measuring the strength of iron, steel, copper, zinc and similar metals or alloys thereof used in many fields of the industry, and identify their rupture values.

2. Description of Related Art Including Information Disclosed Under 37 CFR 1.97 and 37 CFR 1.98.

Today, tensile strength tests are carried out with the help of a laboratory instrument called as Tensile Testing Device. The yield or rupture values are determined with the help of said device by pulling (until rupture) from both ends of a specimen sampled from the material to be tested in compliance with the standards.

At the traditional Tensile Testing devices known in the art, both ends of the milled stud or bolt specimen extracted from the material to be tested are connected to the jaws of the tensile testing device and the specimen test sample is forced to elongation with the motion and force driven to one of the jaws. Such force is maintained until rupture. The result of the tensile test is read from the display of the device after rupture.

By virtue of the tensile testing device, checks concerning the tensile strengths of the flat iron-steel products or profile materials used in the Bosporus Bridge, strength of 8-10 meter-long anchorage stud bolts bearing the bridge legs, conformity of the strength values of the bolts to be used there to the standards, or whether the probable losses at strength for such bolts when they are subjected to anti-corrosion hot-dip galvanized coating process exceeds the values stipulated by the standards are always performed using such tensile testing devices.

However, the tensile testing devices are expensive devices that are not affordable by small scale entrepreneurs as they are not mass-manufactured. Therefore, such devices are rather available in the laboratories at TSE, Kosgeb and Metallurgy, Mechanical Engineering or Civil Engineering departments of the universities, which are financed by the Public. Apart from these, these devices are also available in the laboratories of small number of large-scale automotive, machinery and iron-steel producers.

Tensile testing devices with very high power ratings are available in research laboratories and in some iron-steel production plants. These devices are very scarce in number and their power rating can be up to 150-200 tons at maximum. However, larger tonnages are also required from time to time. The tensile testing benches capable of carrying out tests that require such high power are scarcely any.

The tensile testing devices of the prior art are not achievable by small-scale industries such as SMEs due to both their costs and the challenges in their transportation. Therefore, production of a low-cost and readily portable tensile testing apparatus is required.

U.S. Pat. No. 8,322,227 is a voltage testing device for use in a voltage test propounded for evaluating the connection strength between any body and a compression applying electronic instrument wherein comprising of a base, a voltage meter, a rack and a clamp.

A support member and voltage meter bearing component is located on the base. This part contains a bearing member and a tension portion.

In U.S. Patent No US2014109694, on the other hand, a tensile testing device comprises of a base, a tensiometer and a connection mechanism. An object is adapted stationary at its base. The tensiometer is installed at the moving base and the object to be measured is connected to the tensiometer from its grip part. The connection mechanism includes a resilient member and a positioning member. Resilient member is connected between the base and the tensiometer and then the measurement is carried out. The rack is connected to the tension portion of the part that supports the frame and applies pressure at the base direction. The clamp is placed on the base positioned beside the rack for compressing the pressure applier.

However, as can be seen from the examples given herein above, a low-cost, readily portable tensile testing device employing compression method for tensile test is not designed yet, and the deficiency in this matter is clear.

In conclusion, the need for innovation at the concerned technical field emerged due to problems mentioned above.

### BRIEF SUMMARY OF THE INVENTION

The present invention relates to tensile test apparatus by compression that eliminates all aforementioned disadvantages and that provide some additional benefits to the concerned technical field.

The primary objective of the invention is to propound a tensile test apparatus by employing compression method.

Another objective of the invention is to minimize the costs of the tensile test apparatus.

Another objective of the invention is to propound a low-weight tensile test apparatus that occupies less space and that is readily portable at the trunk of a car if and when needed.

Another objective of the invention is to ensure that the tensile test apparatuses become widespread with an intention to enable even SMEs to access tensile test apparatus.

Another objective of the invention is to solve the problem where tests exceeding 150-160 tons cannot be performed as the maximum power rating of the devices on the market are around 150-160 tons, thus allow execution of tensile tests at higher power ratings.

Another objective of the invention is to end the dependency of the producers to the institutions owning tensile test apparatus and enable each producer to conduct its own tensile test.

Another objective of the invention is to propound an apparatus capable of tensile tests by compression capable of fitting even to the trunk of a car by virtue of its weight of approximately 100 kg by reducing the weight of the tensile test apparatus, which is approximately 2000-3000 kg.

The invention relates to a tensile test apparatus that enables tensile tests on metal (stud/bolt, nut, etc.) test specimens intended to be tensile tested through compression method, characterized in that the apparatus comprises of:
the centering sleeve that enables centering of said tensile test apparatus to fit on the tray of the hydraulic press;
the lower grip part that enables to grip the stud/bolt (test specimen) movably positioned in the center sleeve from one end, and containing pressure applier bearing area on which the pressure applier applies pressure;
the upper grip part that enables to grip the stud/bolt (test specimen) immovably positioned in the center sleeve from the other end, and containing pressure applier holes within which the pressure applier passes through;
the press ram that transfers the compressive force to the lower grip part by means of the pressure appliers.

### BRIEF DESCRIPTION OF THE SEVERAL VIEWS OF THE DRAWINGS

Additional features and advantages of the invention shall be revealed from the exemplary embodiments referring to the accompanying drawings.

FIG. 1 is a dismantled top perspective view of the tensile test apparatus of the invention.

FIG. 2 is a dismantled bottom perspective view of the tensile test apparatus of the invention.

FIG. 3 is an assembled cross-sectional view of the tensile test apparatus of the invention.

FIG. 4 is an assembled cross-sectional view of the tensile test apparatus of the invention.

FIG. 5 is a cross-sectional view of the lower grip part of the tensile test apparatus of the invention.

FIG. 6 is a top view of the lower grip part of the tensile test apparatus of the invention.

FIG. 7 is a cross-sectional view of the upper grip part of the tensile test apparatus of the invention.

FIG. 8 is a top view of the upper grip part of the tensile test apparatus of the invention.

[symbol]

The drawings are not necessarily drawn to scale and details not required for comprehending the present invention might be omitted. Furthermore, elements that are substantially identical at minimum or that have significantly identical functions at minimum are illustrated with same numbers.

### REFERENCE NUMBERS

10—Tensile test Apparatus
20—Centering sleeve
30—Lower grip part
31—Bearing area of the pressure appliers
32—Stud/bolt (test specimen) tapped hole
40—Upper grip part
41—Pressure Applier Holes
42—Stud/bolt (test specimen) Transition Hole
50—Stud/bolt (Test Specimen)
60—Nut
70—Pressure applier
80—Press Ram
81—Force Application Surface

### DETAILED DESCRIPTION OF THE INVENTION

In this detailed description, preferred embodiments of the tensile test apparatus (10) of the invention are explained only for better understanding of the subject and are not intended to be restrictive in any manner.

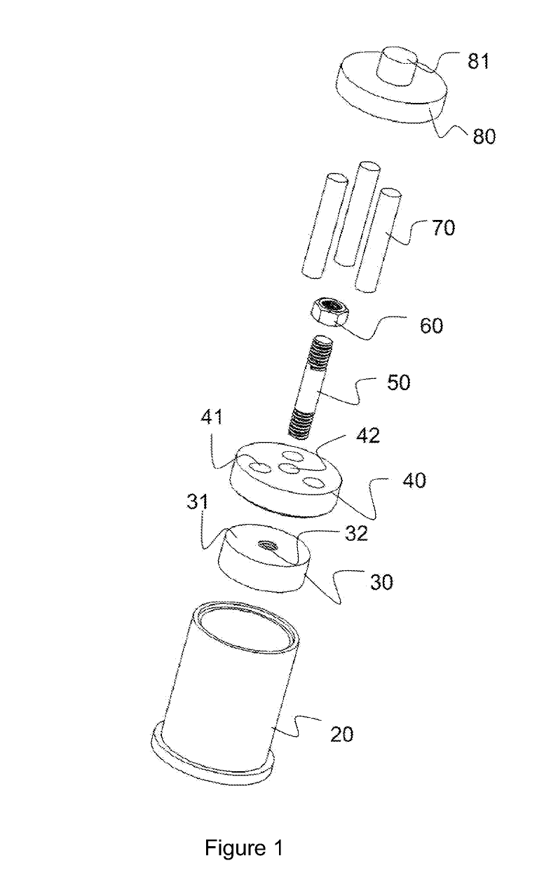

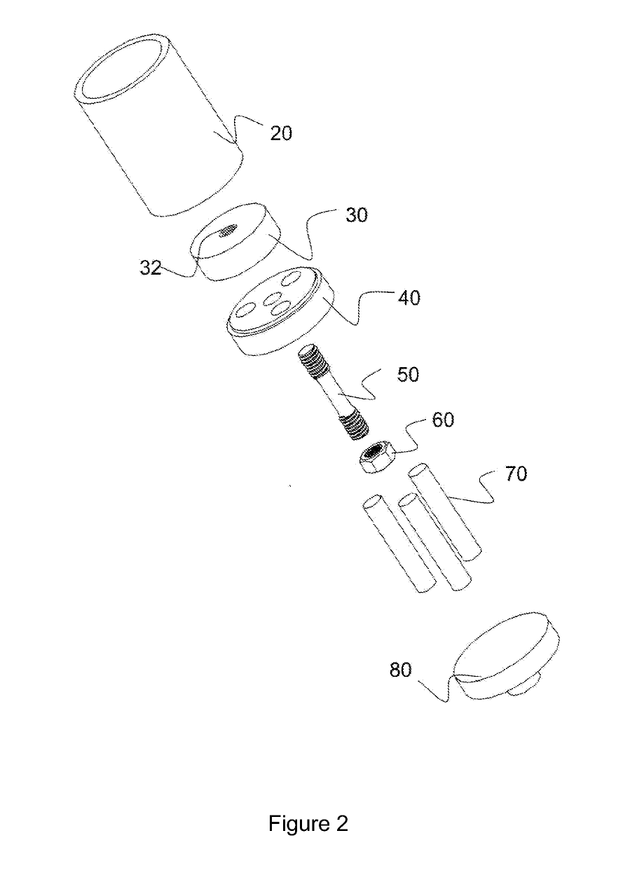

FIG. 1 illustrates the top perspective view of the tensile test apparatus (10) and FIG. 2 illustrates the bottom perspective view. Tensile test apparatus (10) is propounded for the purpose of carrying out tensile tests by compression and is designed with a cylindrical centering sleeve (20) at its preferred embodiment which is shaped to have wider diameter at its bottom side as general appearance. In the centering sleeve (20); there is a round shaped lower grip part (30) capable of seesaw motion, containing stud/bolt (test specimen) tapped hole (32) at its center with top part shaped as bearing area of the pressure appliers (31).

The stud/bolt (test specimen) (50) is fixed to the tapped hole at the center of the lower grip part (30) and the pressure appliers (70) are present on the bearing area of the pressure appliers (31) at the top portion of the lower grip part (30). The pressure appliers (70) and the stud/bolt (test specimen) (50) pass through the upper grip part (40) at the top portion and the stud/bolt (test specimen) (50) pass through the stud/bolt transition hole (42) at the center of the upper grip part (40) and fixed by means of nut (60) from above. The pressure appliers (70), on the other hand, pass through the pressure applier holes (41) on the upper grip part (40) and extend up to the press ram (80) at the top.

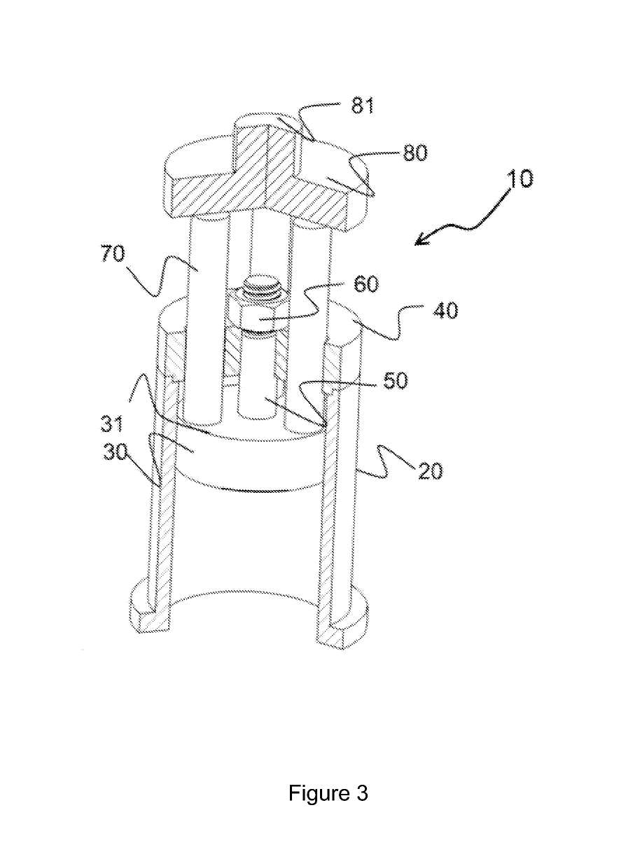

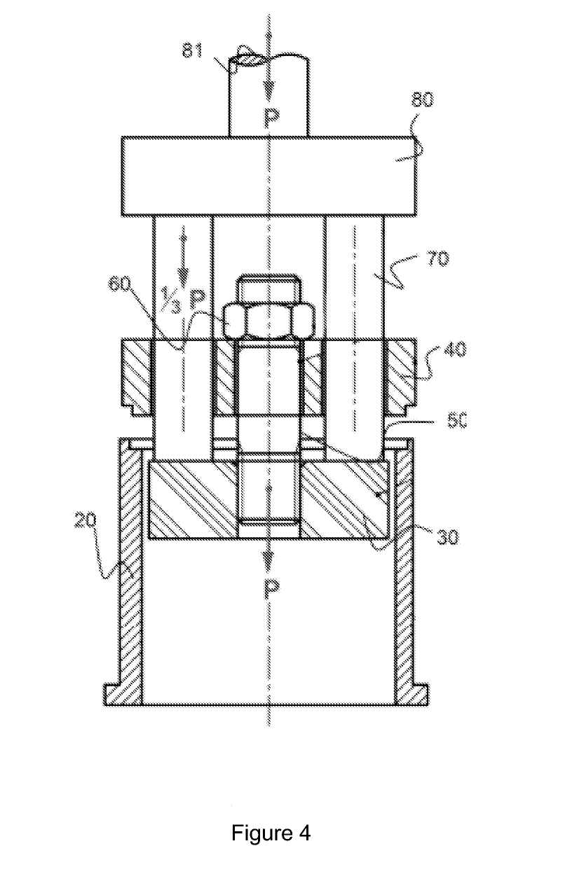

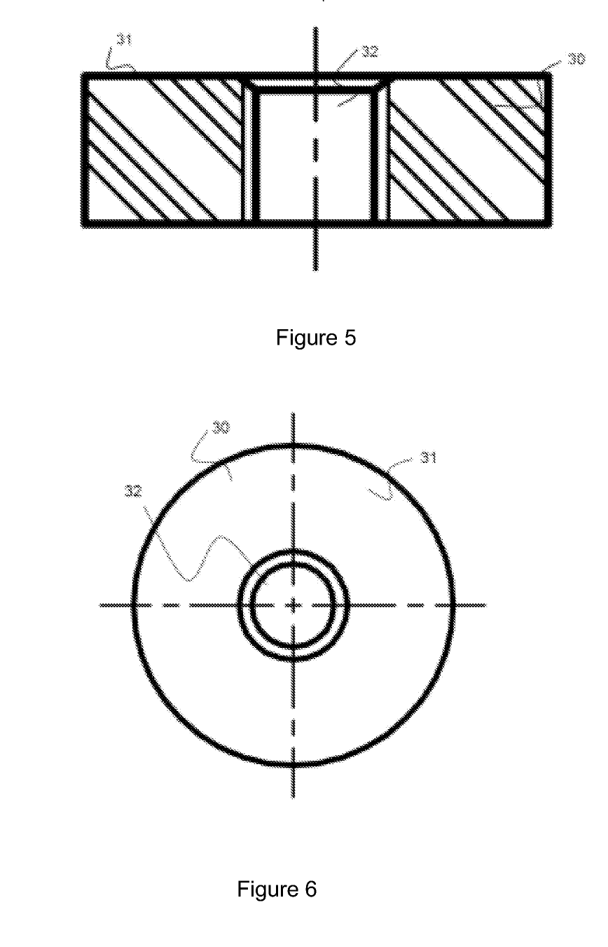

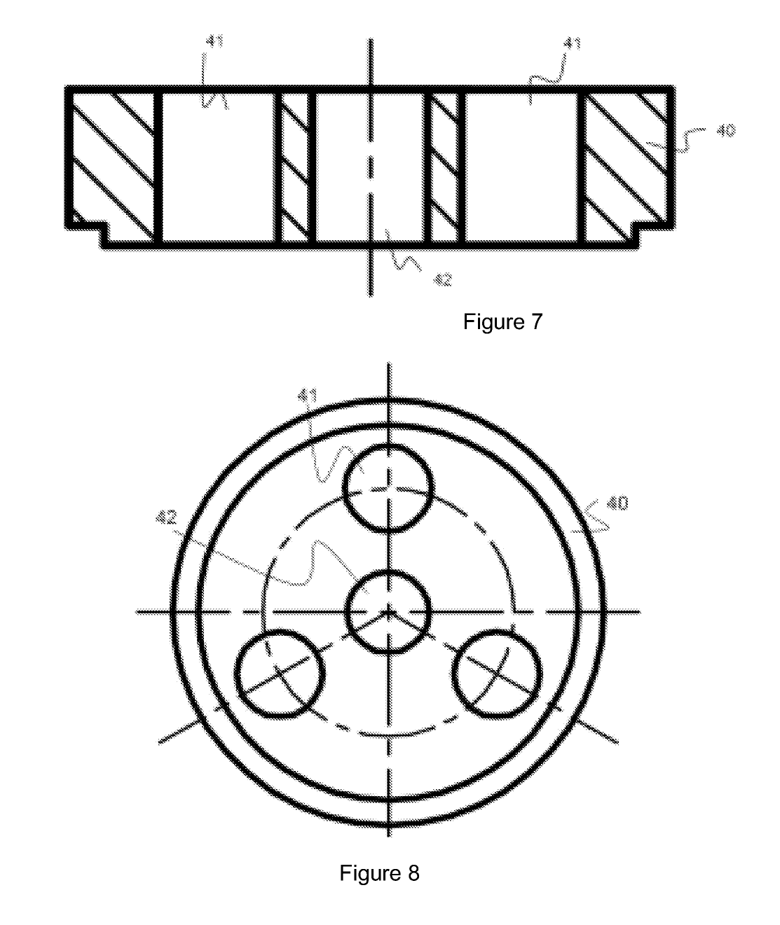

The operating principle of the tensile test apparatus (10), the assembled section of which is illustrated in FIG. 3 and the cross-sectional view of which is illustrated in FIG. 4, is as follows; the centering sleeve (20) is fitted to the tray of the hydraulic press. The stud/bolt (test specimen) (50) to be tested is screwed to the stud/bolt tapped hole (32) located at the center of the lower grip part (30). A tapped hole (32) of adequate size drilled after calculations is located at the center of the lower grip part (30) capable of moving up and down within the centering sleeve (20). Said stud/bolt tapped holes (32) are used to attach the stud/bolt (test specimen) (50) tapped from one or both ends and extracted from the stud/bolt (test specimen) (50) to be tested with the lower grip part (30).

The stud/bolt (test specimen) (50) to be tested, the bottom part of which is fixed to the lower grip part (30) capable of moving up and down within the centering sleeve (20) passes through the stud/bolt (test specimen) transition hole (42) at the upper grip part (40) from its top side and fixed by means of the nut (60) at the upper side of the stud/bolt (test specimen) transition hole (42). The pressure appliers (70) positioned on the pressure applier bearing area (31) on the top surface of the lower grip part (30) passes through the pressure applier holes (41) on the upper grip part (40) and extend up to the press ram (80) at the top. In this manner, the stud/bolt (test specimen) (50) to be tested is grabbed from both ends between the lower grip part (30) at the bottom and the upper grip part (40) at the top within the tensile test apparatus (10). In this case, while the lower grip part (30) is free within the centering sleeve (20) of the tensile test apparatus (10), the upper grip part (40) is fixed in the centering sleeve (80).

The pressure appliers (70), on the other hand, passes through the pressure applier holes (41) located on the upper grip part (40) together with the press ram (80) and the ends of the pressure appliers (70) lean to the bearing area of the pressure appliers (31) located at the top of the lower grip part (30).

The upper tray of the hydraulic press applies force P to the tensile test apparatus from the force application surface (81) at the top of press ram (80). Force P coming from the press ram (80) endeavors to force, elongate and rupture the stud/bolt (test specimen) (50) under test by applying pressure to the lower grip part (30) by means of pressure appliers (70).

Upon rupture, the tensile test by compression method is complete and the value of the rupture strength is read from the display of the Hydraulic Compression Press.

Said tensile test apparatus (10) will be readily portable in such manner to fit into the trunk of any vehicle and will have light weight so that it can be transported to the closest neighbor with pressure press with a private car. The apparatus presents features such as low cost, light-weight, easy transportation.

Another significant feature is that, when it is intended to test strengths such as tensile strength, yield strength, stripping strength without reducing the diameter of the large diameter stud/bolts (50) such as 60-80 mm, a gigantic tensile testing device with 350-400 ton tensile or rupture power, which is not currently available in Turkey, might be needed (its approximate weight is 4000-5000 kg.) However, it would be possible to solve this problem with an apparatus having approximately 100 kg weight, which can be transported at the trunk of a private car by virtue of the present invention.

1. A tensile test apparatus that enables tensile tests on the test specimens such as metallic pieces shaped into stud/bolt by means of a compression method, characterized in comprising;
a centering sleeve that enables centering of said tensile test apparatus to fit on the tray of the hydraulic press;
a lower grip part that enables to grip the stud/bolt (test specimen) movably positioned in the center sleeve from one end, and containing bearing area of the pressure appliers on which a pressure applier applies pressure;
an upper grip part that enables to grip the stud/bolt (test specimen) immovably positioned in the center sleeve from the other end, and containing pressure applier holes within which the pressure applier passes through;
a press ram that transfers the compressive force to the lower grip part by means of the pressure appliers.

2. A tensile test apparatus according to claim 1, characterized in that said tensile apparatus uses pins as the pressure applier.

3. A tensile test apparatus according to claim 1, characterized in comprising a force application surface roughly shaped on the top part of the press ram.
